(19) United States
(12) Patent Application Publication
(10) Pub. No.: US 2024/0284550 A1
(43) Pub. Date: Aug. 22, 2024

(54) METHOD AND DEVICE FOR NETWORK ENERGY SAVING

(71) Applicant: FG Innovation Company Limited, Tuen Mun (HK)

(72) Inventors: TZU-YUEH TSENG, Taipei (TW); YUNG-LAN TSENG, Taipei (TW); TZU-WEN CHANG, Taipei (TW); YEN-HUA LI, Taipei (TW)

(21) Appl. No.: 18/444,612

(22) Filed: Feb. 16, 2024

Related U.S. Application Data
(60) Provisional application No. 63/446,759, filed on Feb. 17, 2023.

(51) Int. Cl. H04W 76/28; H04W 72/1268; H04W 72/1273; H04W 72/231

(52) U.S. Cl. CPC H04W 76/28; H04W 72/1268; H04W 72/1273; H04W 72/231

(57) ABSTRACT

Methods and devices for Network Energy Saving (NES) are provided. The method is performed by a user equipment (UE) and includes receiving, from a base station (BS), a first configuration of a cell-discontinuous transmission (cell-DTX) mechanism; receiving, from the BS, a second configuration of a cell-discontinuous reception (cell-DRX) mechanism; monitoring a physical downlink control channel (PDCCH) of the BS based on the first configuration; and performing an uplink transmission to the BS based on the second configuration.

### CROSS-REFERENCE TO RELATED APPLICATION(S)

The present disclosure claims the benefit of and priority to U.S. Provisional Patent Application Ser. No. 63/446,759, filed on Feb. 17, 2023, entitled “METHODS OF DRX ALIGNMENT FOR THE NETWORK ENERGY SAVING,” the content of which is hereby incorporated herein fully by reference into the present disclosure for all purposes.

### FIELD

The present disclosure generally relates to wireless communications and, more particularly, to methods and devices for Network Energy Saving (NES).

### BACKGROUND

With the tremendous growth in the number of connected devices and the rapid increase in the user/network (NW) traffic volume, various efforts have been made to improve different aspects of wireless communications for next-generation wireless communication systems, such as a fifth-generation (5G) New Radio (NR) communication system, by improving data rate, latency, reliability, and mobility.

The 5G NR system is designed to provide flexibility and configurability to optimize the NW services and types, thus accommodating various use cases, such as enhanced Mobile Broadband (cMBB), massive Machine-Type Communication (mMTC), and Ultra-Reliable and Low-Latency Communication (URLLC).

As the demand for radio access continues to increase, however, there is a need for further improvements in wireless communications in the next-generation wireless communication systems.

### SUMMARY

The present disclosure is directed to methods and devices for Network Energy Saving (NES).

According to a first aspect of the present disclosure, a method performed by a User Equipment (UE) is provided. The method includes receiving, from a base station (BS), a first configuration of a cell-discontinuous transmission (cell-DTX) mechanism; receiving, from the BS, a second configuration of a cell-discontinuous reception (cell-DRX) mechanism; monitoring a physical downlink control channel (PDCCH) of the BS based on the first configuration; and performing an uplink transmission to the BS based on the second configuration.

In some implementations of the first aspect of the present disclosure, the first configuration includes a first discontinuous pattern and a second discontinuous pattern. The method further includes receiving, from the BS, an indication; selecting, based on the indication, one of the first discontinuous pattern and the second discontinuous pattern; and monitoring the PDCCH using the selected one of the first discontinuous pattern and the second discontinuous pattern.

In some implementations of the first aspect of the present disclosure, the second configuration includes a first discontinuous pattern and a second discontinuous pattern. The method further includes receiving, from the BS, an indication; selecting, based on the indication, one of the first discontinuous pattern and the second discontinuous pattern; and performing the uplink transmission using the selected one of the first discontinuous pattern and the second discontinuous pattern.

In some implementations of the first aspect of the present disclosure, the method further includes receiving, from the BS, information related to whether the BS is configured with at least one of the cell-DTX mechanism and the cell-DRX mechanism.

In some implementations of the first aspect of the present disclosure, the information is carried in a radio resource control (RRC) parameter.

In some implementations of the first aspect of the present disclosure, the method further includes sending a scheduling request (SR) to the BS in an active time of the cell-DRX mechanism according to the second configuration.

According to a second aspect of the present disclosure, a User Equipment (UE) is provided. The UE includes one or more non-transitory computer-readable media storing one or more computer-executable instructions; and at least one processor coupled to the one or more non-transitory computer-readable media. The at least one processor configured to execute the one or more computer-executable instructions to cause the UE to receive, from a base station (BS), a first configuration of a cell-discontinuous transmission (cell-DTX) mechanism; receive, from the BS, a second configuration of a cell-discontinuous reception (cell-DRX) mechanism; monitor a physical downlink control channel (PDCCH) of the BS based on the first configuration; and perform an uplink transmission to the BS based on the second configuration.

In some implementations of the second aspect of the present disclosure, the first configuration includes a first discontinuous pattern and a second discontinuous pattern. The at least one processor is configured to execute the computer-executable instructions to further cause the UE to receive, from the BS, an indication; select, based on the indication, one of the first discontinuous pattern and the second discontinuous pattern; and monitor the PDCCH using the selected one of the first discontinuous pattern and the second discontinuous pattern.

In some implementations of the second aspect of the present disclosure, the second configuration includes a first discontinuous pattern and a second discontinuous pattern. The at least one processor is configured to execute the computer-executable instructions to further cause the UE to receive, from the BS, an indication; select, based on the indication, one of the first discontinuous pattern and the second discontinuous pattern; and perform the uplink transmission using the selected one of the first discontinuous pattern and the second discontinuous pattern.

In some implementations of the second aspect of the present disclosure, the at least one processor is configured to execute the computer-executable instructions to further cause the UE to receive, from the BS, information related to whether the BS is configured with at least one of the cell-DTX mechanism and the cell-DRX mechanism.

In some implementations of the second aspect of the present disclosure, the information is carried in a radio resource control (RRC) parameter.

In some implementations of the second aspect of the present disclosure, the at least one processor is configured to execute the computer-executable instructions to further cause the UE to send a scheduling request (SR) to the BS in an active time of the cell-DRX mechanism according to the second configuration.

According to a third aspect of the present disclosure, a Base Station (BS) is provided. The BS includes one or more non-transitory computer-readable media storing one or more computer-executable instructions; and at least one processor coupled to the one or more non-transitory computer-readable media, the at least one processor configured to execute the one or more computer-executable instructions to cause the BS to transmit, to a user equipment (UE), a first configuration of a cell-discontinuous transmission (cell-DTX) mechanism; transmit, to the UE, a second configuration of a cell-discontinuous reception (cell-DRX) mechanism; transmit a physical downlink control channel (PDCCH), to the UE, based on the first configuration; and receive an uplink transmission, from the UE, based on the second configuration.

In some implementations of the third aspect of the present disclosure, the first configuration includes a first discontinuous pattern and a second discontinuous pattern. The at least one processor is configured to execute the computer-executable instructions to further cause the BS to transmit, to the UE, an indication, and the indication indicates one of the first discontinuous pattern and the second discontinuous pattern for the UE to monitor the PDCCH.

In some implementations of the third aspect of the present disclosure, the second configuration includes a first discontinuous pattern and a second discontinuous pattern. The at least one processor is configured to execute the computer-executable instructions to further cause the BS to transmit, to the UE, an indication, and the indication indicates one of the first discontinuous pattern and the second discontinuous pattern for the UE to perform the uplink transmission.

In some implementations of the third aspect of the present disclosure, the at least one processor is configured to execute the computer-executable instructions to further cause the BS to transmit, to the UE, information related to whether the BS is configured with at least one of the cell-DTX mechanism and the cell-DRX mechanism.

In some implementations of the third aspect of the present disclosure, the information is carried in a radio resource control (RRC) parameter.

In some implementations of the third aspect of the present disclosure, the at least one processor is configured to execute the computer-executable instructions to further cause the BS to receive, from the UE, a scheduling request (SR) in an active time of the cell-DRX mechanism according to the second configuration.

### BRIEF DESCRIPTION OF THE DRAWINGS

Aspects of the example disclosure are best understood from the following detailed description when read with the accompanying figures. Various features are not drawn to scale. Dimensions of various features may be arbitrarily increased or reduced for clarity of discussion.

FIG. 1 is a schematic diagram illustrating discontinuous patterns of a BS and two UEs, according to an example implementation of the present disclosure.

FIG. 2 is a schematic diagram illustrating discontinuous patterns of a BS and two UEs, according to an example implementation of the present disclosure.

FIG. 3 is a schematic diagram illustrating discontinuous patterns of a BS and two UEs, according to an example implementation of the present disclosure.

FIGS. 4A, 4B, and 4C are schematic diagrams illustrating different states, according to an example implementation of the present disclosure.

FIG. 5 is a schematic diagram illustrating state transition, according to an example implementation of the present disclosure.

FIG. 6 is a schematic diagram illustrating a state, according to an example implementation of the present disclosure.

FIG. 7 is a schematic diagram illustrating an adjustment of configured grant (CG) uplink (UL) transmissions, according to an example implementation of the present disclosure.

FIGS. 8 and 9 are schematic diagrams illustrating redesigning a discontinuous reception inactivity timer, according to an example implementation of the present disclosure.

FIGS. 10 and 11 are schematic diagrams illustrating redesigning a discontinuous reception retransmission timer for downlink, according to an example implementation of the present disclosure.

FIGS. 12 and 13 are schematic diagrams illustrating redesigning a discontinuous reception retransmission timer for uplink, according to an example implementation of the present disclosure.

FIG. 14 is a schematic diagram illustrating a network energy saving function of two cells, according to an example implementation of the present disclosure.

FIG. 15 is a schematic diagram illustrating switching discontinuous reception patterns, according to an example implementation of the present disclosure.

FIG. 16 is a schematic diagram illustrating a network energy saving function of two cells, according to an example implementation of the present disclosure.

FIG. 17 is a schematic diagram illustrating a discontinuous reception inactivity timer, according to an example implementation of the present disclosure.

FIG. 18 is a flowchart for a method of performing a network energy saving function, according to an example implementation of the present disclosure.

FIG. 19 is a block diagram illustrating a node for wireless communication, according to an example implementation of the present disclosure.

### DETAILED DESCRIPTION

The following description contains specific information pertaining to example implementations in the present disclosure. The drawings in the present disclosure and their accompanying detailed description are directed to merely example implementations. However, the present disclosure is not limited to merely these example implementations. Other variations and implementations of the present disclosure will occur to those skilled in the art. Unless noted otherwise, like or corresponding elements among the figures may be indicated by like or corresponding reference numerals. Moreover, the drawings and illustrations in the present disclosure are generally not to scale and are not intended to correspond to actual relative dimensions.

For the purposes of consistency and ease of understanding, like features may be identified (although, in some examples, not shown) by the same numerals in the example figures. However, the features in different implementations may be differed in other respects, and thus shall not be narrowly confined to what is shown in the figures.

The description uses the phrase “in some implementations,” which may refer to one or more of the same or different implementations. The term “coupled” is defined as connected, whether directly or indirectly through intervening components, and is not necessarily limited to physical connections. The term “comprising,” when utilized, means “including, but not necessarily limited to”; it specifically indicates open-ended inclusion or membership in the so-described combination, group, series and the equivalent. The expression “at least one of A, B and C,” “at least one of the following: A, B and C,” “at least one of A, B or C,” and “at least one of the following: A, B or C” means “only A, or only B, or only C, or any combination of A, B and C.”

Additionally, for the purposes of explanation and non-limitation, specific details, such as functional entities, techniques, protocols, standard, and the like are set forth for providing an understanding of the described technology. In other examples, detailed description of well-known methods, technologies, systems, architectures, and the like are omitted so as not to obscure the description with unnecessary details.

Persons skilled in the art will immediately recognize that any NW function(s) or algorithm(s) described in the present disclosure may be implemented by hardware, software, or a combination of software and hardware. Described functions may correspond to modules which may be software, hardware, firmware, or any combination thereof. The software implementation may include computer executable instructions stored on computer readable medium, such as a memory or other types of storage devices. For example, one or more microprocessors or general-purpose computers with communication processing capability may be programmed with corresponding executable instructions and carry out the described NW function(s) or algorithm(s). The microprocessors or general-purpose computers may be formed of Application-Specific Integrated Circuits (ASICs), programmable logic arrays, and/or one or more Digital Signal Processor (DSPs). Although some of the example implementations described in this specification are oriented to software installed and executing on computer hardware, nevertheless, alternative example implementations implemented as firmware, as hardware, or as a combination of hardware and software are well within the scope of the present disclosure.

The computer readable medium includes, but is not limited to, Random Access Memory (RAM), Read Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication NW architecture (e.g., a Long Term Evolution (LTE) system, an LTE-Advanced (LTE-A) system, an LTE-Advanced Pro system, or a 5G New Radio (NR) Radio Access Network (RAN)) typically includes at least one Base Station (BS), at least one User Equipment (UE), and one or more optional NW elements that provide connection toward the NW. The UE communicates with the NW (e.g., a Core Network (CN), an Evolved Packet Core (EPC) NW, an Evolved Universal Terrestrial Radio Access Network (E-UTRAN), a 5G Core (5GC), or an internet), through a RAN established by one or more BSs.

It should be noted that, in the present application, a UE may include, but is not limited to, a mobile station, a mobile terminal or device, or a user communication radio terminal. For example, a UE may be a portable radio equipment, which includes, but is not limited to, a mobile phone, a tablet, a wearable device, a sensor, a vehicle, or a Personal Digital Assistant (PDA) with wireless communication capability. The UE is configured to receive and transmit signals over an air interface to one or more cells in a radio access NW.

A BS may be configured to provide communication services according to at least one of the following Radio Access Technologies (RATs): Worldwide Interoperability for Microwave Access (WiMAX), Global System for Mobile communications (GSM, often referred to as 2G), GSM Enhanced Data rates for GSM Evolution (EDGE) Radio Access Network (GERAN), General Packet Radio Service (GPRS), Universal Mobile Telecommunication System (UMTS, often referred to as 3G) based on basic Wideband-Code Division Multiple Access (W-CDMA), High-Speed Packet Access (HSPA), LTE, LTE-A, cLTE (evolved LTE, e.g., LTE connected to 5GC), NR (often referred to as 5G), and/or LTE-A Pro. However, the scope of the present application should not be limited to the above-mentioned protocols.

A BS may include, but is not limited to, a node B (NB) as in the UMTS, an evolved Node B (cNB) as in the LTE or LTE-A, a Radio Network Controller (RNC) as in the UMTS, a Base Station Controller (BSC) as in the GSM/GERAN, a ng-cNB as in an Evolved Universal Terrestrial Radio Access (E-UTRA) BS in connection with the 5GC, a next-generation Node B (gNB) as in the 5G-RAN, and any other apparatus capable of controlling radio communication and managing radio resources within a cell. The BS may serve one or more UEs through a radio interface.

The BS is operable to provide radio coverage to a specific geographical area using a plurality of cells forming the radio access NW. The BS supports the operations of the cells. Each cell is operable to provide services to at least one UE within its radio coverage. More specifically, each cell (often referred to as a serving cell) provides services to serve one or more UEs within its radio coverage (e.g., each cell schedules the downlink (DL) and optionally uplink (UL) resources to at least one UE within its radio coverage for DL and optionally UL packet transmissions). The BS may communicate with one or more UEs in the radio communication system through the plurality of cells. A cell may allocate Sidelink (SL) resources for supporting Proximity Service (ProSe) or Vehicle to Everything (V2X) service. Each cell may have overlapped coverage areas with other cells.

As discussed above, the frame structure for NR is to support flexible configurations for accommodating various next-generation (e.g., 5G) communication requirements, such as Enhanced Mobile Broadband (cMBB), Massive Machine Type Communication (mMTC), Ultra-Reliable and Low-Latency Communication (URLLC), while fulfilling high reliability, high data rate and low latency requirements. The Orthogonal Frequency-Division Multiplexing (OFDM) technology as agreed in the 3^{rd} Generation Partnership Project (3GPP) may serve as a baseline for NR waveform. The scalable OFDM numerology, such as the adaptive sub-carrier spacing, the channel bandwidth, and the Cyclic Prefix (CP) may also be used. Additionally, two coding schemes are considered for NR: (1) Low-Density Parity-Check (LDPC) code and (2) Polar Code. The coding scheme adaption may be configured based on the channel conditions and/or the service applications.

Moreover, it is also considered that in a transmission time interval TX of a single NR frame, a DL transmission data, a guard period, and an UL transmission data should at least be included, where the respective portions of the DL transmission data, the guard period, and the UL transmission data should also be configurable, for example, based on the NW dynamics of NR. In addition, SL resources may also be provided in an NR frame to support ProSe services or V2X services.

In addition, the terms “system” and “NW” herein may be used interchangeably. The term “and/or” herein is only an association relationship for describing associated objects, and represents that three relationships may exist. For example, A and/or B may indicate that A exists alone, A and B exist at the same time, or B exists alone. In addition, the character “/” herein generally represents that the former and latter associated objects are in an “or” relationship. Multiple PLMNs may operate on the unlicensed spectrum. Multiple PLMNs may share the same unlicensed carrier. The PLMNs may be public or private. Public PLMNs may be (but not limited to) the operators or virtual operators, which provides radio services to the public subscribers. Public PLMNs may own the licensed spectrum and support the radio access technology on the licensed spectrum as well. Private PLMNs may be (but not limited to) the micro-operators, factories, or enterprises, which provides radio services to its private users (e.g., employees or machines). In some implementations, public PLMNs may support more deployment scenarios (e.g., carrier aggregation between licensed band NR (PCell) and NR-U (SCell), dual connectivity between licensed band LTE (PCell) and NR-U (PSCell), stand-alone NR-U, an NR cell with DL in unlicensed band and UL in licensed band, dual connectivity between licensed band NR (PCell) and NR-U (PSCell)). In some implementations, private PLMNs mainly support (but not limited to) the stand-alone unlicensed radio access technology (e.g., stand-alone NR-U).

Some of the terms, definitions, and abbreviations, as given in this disclosure, are either also found in existing documentation (European Telecommunications Standards Institute (ETSI), International Telecommunication Union (ITU), etc.) or may have been newly created by the 3GPP experts, for example, in the case that there was a need for a precise vocabulary.

In the context of environmental sustainability and reducing operational costs, Network Energy Saving (NES) takes on critical significance in diminishing environmental impacts, notably greenhouse gas emissions. With the widespread adoption of 5G across various industries and regions, the network infrastructures required to manage more sophisticated services and applications that demand high data rates are evolving. These infrastructures are becoming increasingly complex, utilizing a greater number of antennas, broader bandwidths, and multiple frequency bands. Given this expansion, it's vital to maintain the environmental impact of 5G within manageable limits. Developing effective solutions for enhancing network energy efficiency is therefore essential.

In some implementations, gNBs may employ a Cell-Discontinuous Reception (C-DRX) mechanism to reduce downlink transmission and uplink reception activities. However, the C-DRX settings for different UEs within a serving cell may vary, potentially, leading to reduced the network off-time. Aligning the C-DRX cycles of various UEs is a pivotal strategy that may significantly lower the network's power consumption.

In some implementations, part, or all, of the details related to a discontinuous reception (DRX) mechanism may be implemented in the C-DRX mechanism. The details related to the DRX mechanism are described below.

### DRX

When a UE operates in the RRC_CONNECTED state, the UE (e.g., the MAC entity of the UE) may be configured with a DRX functionality by RRC signaling and/or by a BS. The DRX functionality may regulate the PDCCH monitoring activities of the UE. If the DRX functionality is configured, the UE may, for all activated serving cells, discontinuously monitor the PDCCH based on the DRX configuration. The operations related to the DRX may be characterized by at least one of an on-duration, a DRX cycle, a DRX inactivity time, a DRX retransmission timer, a DRX Hybrid Automatic Repeat reQuest (HARQ) Round Trip Time (RTT) timer, a DRX slot offset, and an active time.

The on-duration may be a duration controlled by drx-onDurationTimer, during which, the UE waits for receiving PDCCHs after waking up. If the UE successfully decodes a PDCCH indicating new DL data reception or new UL transmission, the UE may stay awake and start a drx-inactivity-timer.

The DRX cycle may specify the periodic repetition of the on-duration followed by a potential inactivity period. The inactivity period may be configured by a drx-LongCycleStartOffset, a drx-ShortCycle, and/or a drx-ShortCycleTimer.

The DRX inactivity timer may be a duration controlled by the drx-InactivityTimer, starting from the UE's last successful PDCCH decoding. If no PDCCH is successfully decoded, while the drx-InactivityTimer is running, the UE may revert to sleep mode. The UE may (re-)start the drx-InactivityTimer following a successful decoding of a PDCCH for a new transmission (e.g., excluding the retransmissions).

The DRX retransmission timer, controlled by a drx-RetransmissionTimerDL and a drx-RetransmissionTimerUL, may define a duration in which a retransmission is expected.

The DRX HARQ RTT Timer may be a minimum duration before a DL assignment for the HARQ retransmission (e.g., configured by a drx-HARQ-RTT-TimerDL), or before a UL HARQ retransmission grant (e.g., configured by a drx-HARQ-RTT-TimerUL).

The DRX slot offset may be a delay before starting a drx-onDurationTimer. The DRX slot offset may be configured by a drx-SlotOffset.

The active time may be a total duration that the UE monitors the PDCCH. The total duration may include the “on-duration” of the DRX cycle, the time the UE is performing continuous reception while the inactivity timer is running, and the time the UE is performing continuous reception while awaiting a retransmission opportunity.

Specifically, when the DRX functionality is configured, the active time for the serving cells may include:
the time duration in which the drx-onDurationTimer or the drx-InactivityTimer is running;
the time duration in which the drx-RetransmissionTimerDL or the drx-RetransmissionTimerUL is running on any serving cell;
the time duration in which the ra-ContentionResolutionTimer or the msgB-Response Window is running;
the time duration in which a Scheduling Request (SR) on a Physical Uplink Control CHannel (PUCCH) is pending; or
the time duration in which a PDCCH indicating a new transmission addressed to the C-RNTI of the MAC entity has not been received after a successful reception of a Random Access Response (RAR) for the Random Access (RA) preamble that is not selected (e.g., by the MAC entity) from a set of contention-based RA preambles.

### Dci Format2_6

In some implementations, the DCI that is described in the present disclosure may include a DCI format for scheduling a Physical Uplink Shared CHannel (PUSCH) (e.g., formats 0_0, 0_1, 0_2) and/or PDSCH (e.g., formats 1_0, 1_1, 1_2).

In some implementations, the DCI described in the present disclosure may include a DCI format for other purposes. For example, the DCI format 2_6 may be used for notifying power-saving information outside of the DRX active time for one or more UEs. The DCI format 2_6 may be, for example, DCI scrambled by a Power Saving Radio Network Temporary Identifier (PS-RNTI), which may be also known as the DCI with CRC scramble by the PS-RNTI (DCP).

In some implementations, contents related to the DCI format 2_6 may be documented, as shown in Table 1 below.

TABLE 1
A UE configured with DRX mode operation [11, TS 38.321] can be provided the following for detection
of a DCI format 2_6 in a PDCCH reception on the PCell or on the SpCell [12, TS 38.331]

| | |
|---|---|
| - | a PS-RNTI for DCI format 2_6 by ps-RNTI |
| - | a number of search space sets, by dci-Format2-6, to monitor PDCCH for detection of DCI format |

2_6 on the active DL BWP of the PCell or of the SpCell according to a common search space as described
in clause 10.1

| | |
|---|---|
| - | a payload size for DCI format 2_6 by sizeDCI-2-6 |
| - | a location in DCI format 2_6 of a Wake-up indication bit by ps-PositionDCI-2-6 |
| - | a ‘0’ value for the Wake-up indication bit, when reported to higher layers, indicates to not start |

the drx-onDurationTimer for the next long DRX cycle [11, TS 38.321]

| | |
|---|---|
| - | a ‘1’ value for the Wake-up indication bit, when reported to higher layers, indicates to start the |

drx-onDurationTimer for the next long DRX cycle [11, TS 38.321]

| | |
|---|---|
| - | a bitmap, when the UE is provided a number of groups of configured SCells by |

dormancyGroupOutsideActiveTime, where

| | |
|---|---|
| - | the bitmap location is immediately after the Wake-up indication bit location |
| - | the bitmap size is equal to the number of groups of configured SCells where each bit of the |

bitmap corresponds to a group of configured SCells from the number of groups of configured SCells

| | |
|---|---|
| - | a ‘0’ value for a bit of the bitmap indicates an active DL BWP, provided by dormantBWP-Id, for |

the UE [11, TS38.321] for each activated SCell in the corresponding group of configured SCells

| | |
|---|---|
| - | a ‘1’ value for a bit of the bitmap indicates |
| - | an active DL BWP, provided by firstOutsideActiveTimeBWP-Id, for the UE for each activated |

SCell in the corresponding group of configured SCells, if a current active DL BWP is the dormant DL
BWP

| | |
|---|---|
| - | a current active DL BWP, for the UE for each activated SCell in the corresponding group of |

configured SCells, if the current active DL BWP is not the dormant DL BWP

| | |
|---|---|
| - | the UE sets the active DL BWP to the indicated active DL BWP |

an offset by ps-Offset indicating a time, where the UE starts monitoring PDCCH for detection of
DCI format 2_6 according to the number of search space sets, prior to a slot where the drx-
onDurationTimer would start on the PCell or on the SpCell [11, TS 38.321]

| | |
|---|---|
| - | for each search space set, the PDCCH monitoring occasions are the ones in the first Tₛ slots |

indicated by duration, or Tₛ = 1 slot if duration is not provided, starting from the first slot of the first Tₛ
slots and ending prior to the start of drx-onDurationTimer.
On PDCCH monitoring occasions associated with a same long DRX Cycle, a UE does not expect to
detect more than one DCI format 2_6 with different values of the Wake-up indication bit for the UE or
with different values of the bitmap for the UE.
The UE does not monitor PDCCH for detecting DCI format 2_6 during Active Time [11, TS 38.321].

### DRX Command MAC CE/Long DRX Command MAC CE

The DRX Command Media Access Control (MAC) Control Element (CE) may be identified by a MAC subheader with a Logical Channel IDentifier (LCID), for example, as specified in TS 38.331 Table 6.2.1-1. The DRX command MAC CE may have a fixed size of zero bits.

The Long DRX Command MAC CE may be identified by a MAC subheader with LCID as specified in TS 38.331 Table 6.2.1-1. The DRX command MAC CE may have a fixed size of zero bits.

Specifically, specific indications, such as the (long) DRX command MAC CE, may be received on a specific CORESET/search space/PDCCH.

In some implementations, contents related to the (long) DRX command MAC CE may be documented, as shown in Table 2 below.

TABLE 2

| 1> | if a DRX Command MAC CE with DCI scrambled with C-RNTI for unicast transmission or a Long | |
|---|---|---|
| | DRX Command MAC CE is received: | |
| | 2> | stop drx-onDurationTimer for each DRX group; |
| | 2> | stop drx-InactivityTimer for each DRX group. |
| 1> | if drx-InactivityTimer for a DRX group expires: | |
| | 2> | if the Short DRX cycle is configured: |

| | |
|---|---|
| 3> | start or restart drx-ShortCycleTimer for this DRX group in the first symbol after the |
| | expiry of drx-InactivityTimer; |
| 3> | use the Short DRX cycle for this DRX group. |

| | |
|---|---|
| 2> | else: |

| | |
|---|---|
| 3> | use the Long DRX cycle for this DRX group. |

| 1> | if a DRX Command MAC CE with DCI scrambled with C-RNTI for unicast transmission is | |
|---|---|---|
| | received: | |
| | 2> | if the Short DRX cycle is configured: |

| | |
|---|---|
| 3> | start or restart drx-ShortCycleTimer for each DRX group in the first symbol after the end |
| | of DRX Command MAC CE reception; |
| 3> | use the Short DRX cycle for each DRX group. |

| | |
|---|---|
| 2> | else: |

| | |
|---|---|
| 3> | use the Long DRX cycle for each DRX group. |

| 1> | if drx-ShortCycleTimer for a DRX group expires: | |
|---|---|---|
| | 2> | use the Long DRX cycle for this DRX group. |
| 1> | if a Long DRX Command MAC CE is received: | |
| | 2> | stop drx-ShortCycleTimer for each DRX group; |
| | 2> | use the Long DRX cycle for each DRX group. |

Some implementations of the present disclosure provide examples of mechanisms for aligning the UE DRX and communicating to the UE about the cell's active status. Enhancements in the UE DRX configuration settings are provided in the present disclosure. To enable the UE DRX alignment and to utilize the Cell Discontinuous Transmission (C-DTX) and/or C-DRX for NES, a few issues (e.g., issues I to V) that need to be addressed are described below.

### I. Definitions Related to Cell-DTX/DRX

It should be noted that, in the present disclosure, a C-DTX and a C-DRX may also be referred as a cell-DTX and a cell-DRX, respectively.

Understanding the concept of the cell DTX/DRX is pivotal for the NES. Moreover, the definition of the UE DRX is a significant factor in determining whether the network is able to provide specific services. Additionally, the control and data signals within a cell DTX/DRX network requires clarification.

The definitions of cell-DTX and cell-DRX may be articulated as follows.

Cell-DTX Definition: The cell-DTX may be defined by taking into account the UE DRX definition and pattern. Specifically, the MAC entity of the UE may be configured by RRC (e.g., signaling) with a DRX functionality. The DRX functionality may dictate the UE's PDCCH monitoring activities for the MAC entity's C-RNTI, CI-RNTI, CS-RNTI, INT-RNTI, SFI-RNTI, SP-CSI-RNTI, TPC-PUCCH-RNTI, TPC-PUSCH-RNTI, TPC-SRS-RNTI, AI-RNTI, SL-RNTI, SLCS-RNTI, and SL Semi-Persistent Scheduling V-RNTI. Consequently, the cell-DTX may be active when said PDCCH and its associated signals (e.g., PDSCH) are being transmitted.

Cell-DRX Definition: The cell-DRX may be defined by taking into account the UE DTX definition and pattern. Not only the reception, by the UE, of a periodic and semi-persistent Sounding Reference Signals (SRS) and Channel State Information (CSI) reporting on the PUCCH, the UE DTX may also dictate the Configured Grant (CG) UL, HARQ Feedback, aperiodic CSI reporting, aperiodic SRS, and the SR.

Introduction of cell-DX: The term “cell-DX” may be used for describing active periods of the BS, which may also be referred to as cell DTX/DRX. The cell-DX encompasses subcategories, such as the cell-DTX and cell-DRX.

### II. Alignment Method

Typically, a cell may stay active as long as the UEs within the cell's serving range are active. However, since the DRX patterns may vary among different UEs, a legacy network may experience prolonged active time due to unaligned active times of the Ues. Implementing an alignment method to maximize the overlap in the active time of the UEs within a cell may substantially decrease the active time of the cell, leading to notable energy savings in the network.

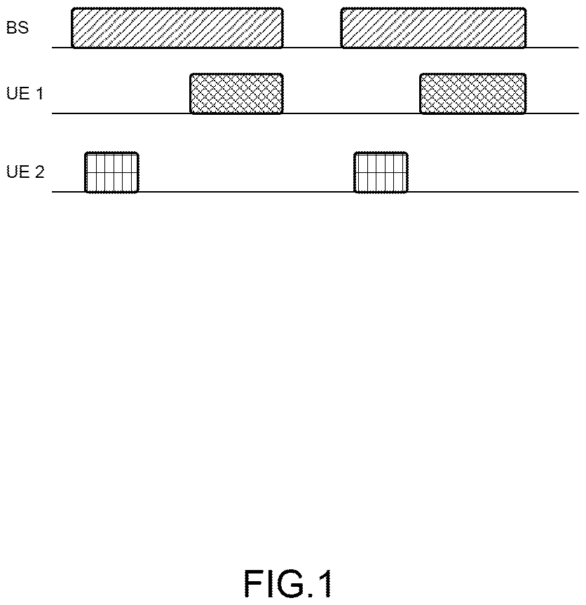

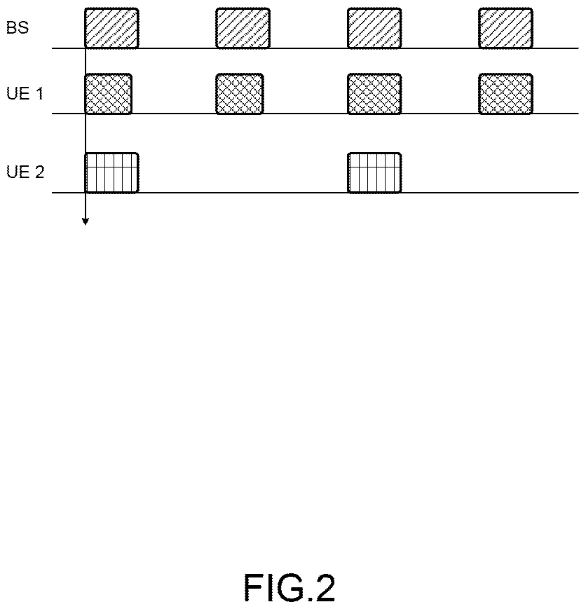

FIG. 1 is a schematic diagram illustrating discontinuous patterns of a BS and two UEs, according to an example implementation of the present disclosure. FIG. 2 is a schematic diagram illustrating discontinuous patterns of a BS and two UEs, according to an example implementation of the present disclosure.

It should be noted that, in the present disclosure, in figures similar to FIG. 1, the horizontal axes are used to represent time, while the blocks on the horizontal axes indicate active times.

Referring to FIGS. 1 and 2, active times of a BS, a first UE (e.g., UE 1), and a second UE (e.g., UE 2) are illustrated. The BS may configure the DRX patterns for the UEs and calculate the greatest common factor of active time (e.g., intersecting active time) based on the DRX patterns (e.g., drx-OnDurationTimer). The greatest common factor of active time may be referred to as the “base active time” (e.g., the active time of the second UE illustrated in FIG. 2). In a case that a UE's active period is approximately equal to a number of times of the base active time (e.g., the active time of the first UE illustrated in FIG. 1 being two times of the base active time), the active period may be segmented into the base active time and then the base active time may be repeated by the number of times (e.g., the active time of the first UE illustrated in FIG. 2).

In some implementations, the network may define its cell-DX pattern and subsequently determine the DRX patterns for various UEs based on the defined cell-DX pattern.

In some implementations, the cell-DX pattern may be calculated based on the base active time and the number of the repeated times (e.g., the active time of the BS illustrated in FIG. 2).

In some implementations, the cell-DX pattern may be configured by the cell-DX parameter(s) including at least one of the cell-DX offset, the cell-DX cycle, and the cell-DX active time. The cell-DX parameter(s) may be described in the new DRX-config IE(s) in the DRX-Config-NES (e.g., in an RRC message).

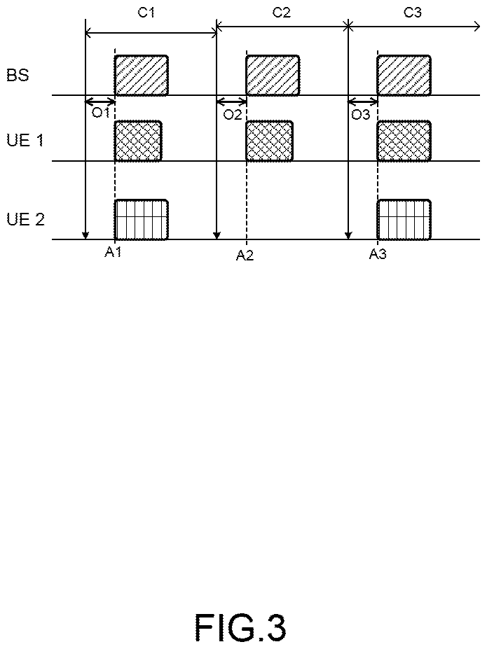

FIG. 3 is a schematic diagram illustrating discontinuous patterns of a BS and two UEs, according to an example implementation of the present disclosure. The cell-DX parameter(s) or the new DRX-config IE(s) may be defined and described below with reference to FIG. 3.
cell-DX offset INTEGER (0 . . . 31)

Referring to FIG. 3, the cell-DX offset may be used to configure the offset O1, O2, O3, between the start of the cycle C1, C2, C3 and the start of the active time A1, A2, A3. In some implementations, the unit of the cell-DX offset may be slot/subframe.
cell-DX cycle ENUMERATED {ms10, ms20, ms32, ms40, ms60, ms64, ms70, ms80, ms128, ms160, ms256, ms320, ms512, ms640, ms1024, ms1280, ms2048, ms2560, ms5120, ms10240}

Referring to FIG. 3, the cell-DX cycle may be used to configure the cycle C1, C2, C3 of the network.

| | |
|---|---|
| - cell-DX active time | CHOICE {subMilliSeconds INTEGER (1...31), |
| | milliSeconds ENUMERATED {ms1, ms2, ms3, |

ms4, ms5, ms6, ms8, ms10, ms20, ms30, ms40, ms50, ms60, ms80, ms100, ms200, ms300, ms400,
ms500, ms600, ms800, ms1000, ms1200, ms1600, spare8, spare7, spare6, spare5, spare4, spare3,
spare2, spare 1 }

}

Referring to FIG. 3, the cell-DX active time may be used to configure the active time A1, A2, A3 of the network.

In some implementations, the new DRX-config IE(s) in the DRX-config-NES in the RRC message may include at least one of the above cell-DX parameter(s) or IE(s) and the DRX-Config IEs listed in Table 3 below.

TABLE 3
-- ASN1START
-- TAG-DRX-CONFIG-START

| | |
|---|---|
| DRX-Config ::= | SEQUENCE { |
| drx-onDurationTimer | CHOICE { |
| | subMilliSeconds INTEGER (1..31), |
| | milliSeconds ENUMERATED { |
| | ms1, ms2, ms3, ms4, ms5, ms6, ms8, ms10, ms20, ms30, ms40, |
| | ms50, ms60, ms80, ms100, ms200, ms300, ms400, ms500, ms600, |
| | ms800, ms1000, ms1200, ms1600, spare8, spare7, spare6, spare5, |
| | spare4, spare3, spare2, spare1 } |
| | } |
| drx-InactivityTimer | ENUMERATED { |
| | ms0, ms1, ms2, ms3, ms4, ms5, ms6, ms8, ms10, ms20, ms30, |
| | ms40, ms50, ms60, ms80, ms100, ms200, ms300, ms500, ms750, |
| | ms1280, ms1920, ms2560, spare9, spare8, spare7, spare6, spare5, |
| | spare4, spare3, spare2, spare1}, |
| | } |

| | |
|---|---|
| drx-HARQ-RTT-TimerDL | INTEGER (0..56), |
| drx-HARQ-RTT-TimerUL | INTEGER (0..56), |
| drx-Retransmission TimerDL | ENUMERATED { |

```
      sl0, sl1, sl2, sl4, sl6, sl8, sl16, sl24, sl33, sl40, sl64, sl80, sl96,
      sl112, sl128, sl160, sl320, spare15, spare14, spare13, spare12,
      spare11, spare10, spare9, spare8, spare7, spare6, spare5, spare4,
      spare3, spare2, spare1},
```

| | |
|---|---|
| drx-Retransmission TimerUL | ENUMERATED { |

```
      sl0, sl1, sl2, sl4, sl6, sl8, sl16, sl24, sl33, sl40, sl64, sl80, sl96,
      sl112, sl128, sl160, sl320, spare15, spare14, spare13, spare12,
      spare11, spare10, spare9, spare8, spare7, spare6, spare5, spare4,
      spare3, spare2, spare1 },
```

| | |
|---|---|
| drx-LongCycleStartOffset | CHOICE { |

```
      ms10 INTEGER(0..9),
      ms20 INTEGER(0..19),
      ms32 INTEGER(0..31),
      ms40 INTEGER(0..39),
      ms60 INTEGER(0..59),
      ms64 INTEGER(0..63),
      ms70 INTEGER(0..69),
      ms80 INTEGER(0..79),
      ms128 INTEGER(0..127),
      ms160 INTEGER(0..159),
      ms256 INTEGER(0..255),
      ms320 INTEGER(0..319),
      ms512 INTEGER(0..511),
      ms640 INTEGER(0..639),
      ms1024 INTEGER(0..1023),
      ms1280 INTEGER(0..1279),
      ms2048 INTEGER(0..2047),
      ms2560 INTEGER(0..2559),
      ms5120 INTEGER(0..5119),
      ms10240 INTEGER(0..10239)
```

},

| | |
|---|---|
| shortDRX | SEQUENCE { |
| drx-ShortCycle | ENUMERATED { |
| | ms2, ms3, ms4, ms5, ms6, ms7, ms8, ms10, ms14, ms16, ms20, |
| | ms30, ms32, ms35, ms40, ms64, ms80, ms128, ms160, ms256, |
| | ms320, ms512, ms640, spare9, spare8, spare7, spare6, spare5, |
| | spare4, spare3, spare2, spare 1 }, |

| | |
|---|---|
| drx-ShortCycle Timer | INTEGER (1..16) |

}
OPTIONAL, -- Need R

| | |
|---|---|
| drx-SlotOffset | INTEGER (0..31) |

}
-- TAG-DRX-CONFIG-STOP
-- ASN1STOP

To enhance the network stability in certain applications, such as those insensitive to a delay, the network may maintain the DRX-Config-NES for a specified duration. A new IE NES-prohibit-timer may be defined in the DRX-Config-NES. The network may retain the same cell pattern at least until the NES-prohibit-timer expires. The value of the NES-prohibit-timer may be set as integer multiples of the cell-DX cycle. For example, the newly introduced NES-prohibit-timer may be defined in the DRX-config-NES as:
NES-prohibit-timer
ENUMERATED {ms10, ms20, ms32, ms40, ms60, ms64, ms70, ms80, ms128, ms160, ms256, ms320, ms512, ms640, ms1024, ms1280, ms2048, ms2560, ms5120, ms10240}.

### III. How UEs Acquire Configurations from the Network

To ensure effective communication between the UEs and the network, it may be crucial for the UEs to acquire relevant configurations from the network. These configurations may include both a common network configuration pattern (e.g., the pattern of the BS, as illustrated in FIG. 2) and the UE-specific configuration patterns (e.g., patterns of the first UE and the second UE, as illustrated in FIG. 2).

Regarding the UE-specific configuration patterns, in some implementations, the UE (e.g., MAC entity) may be configured with a DRX functionality by RRC signaling and/or by a BS. The DRX functionality may regulate the PDCCH monitoring activities of the UE.

Regarding the common network configuration pattern, in some implementations, the network may use the UE-specific signaling or common control signaling to ensure that all UEs within the serving cell are informed about the common network configurations (e.g., common network pattern).

Example implementations of the methods for the network to communicate the common network configurations to the UEs are described below.

Method 1: UE Specific Control Signaling (e.g. RRC Signaling)

The cell-DX parameter(s), as mentioned above, may be newly introduced in the information element(s) (IE(s)) within the DRX-config-NES in the RRC message. The RRC information (e.g., DRX-config-NES) may be contained within the PDSCH, and the PDSCH may be indicated by the DCI scrambled with the C-RNTI for a specific UE. The UE is required to monitor the UE-Specific Search Space (USS), which is configured by the SearchSpace in the PDCCH-Config with searchSpaceType=ue-Specific for DCI format with CRC scrambled by C-RNTI.

### Method 2: Common Control Signaling (e.g., Other SIB)

The network may utilize other SIB(s) to inform the UEs about the cell-DX pattern. SIB1, for instance, may provide information about the availability and scheduling of the other SIB(s) that are relevant to the cell-DX pattern.

A new SIB IE, such as SIBXX, may be introduced. The SIBXX may include at least three IEs related to the cell-DX pattern, the IEs including, for example, the cell-DX offset, cell-DX cycle, and cell-DX active time, as shown in Table 4 below. To access this information, the UEs may be required to monitor the Type0A-PDCCH CSS set, which is configured by the searchSpaceOtherSystemInformation in the PDCCH-ConfigCommon for the DCI format with CRC scrambled by the SI-RNTI.

TABLE 4

| SIBXX-r18 ::= | SEQUENCE { | |
|---|---|---|
| cell-DX offset | Cell-DX offset | OPTIONAL, -- Need S |
| cell-DX cycle | Cell-DX cycle | OPTIONAL, -- Need S |
| Cell-DX active time | Cell-DX active time | OPTIONAL, -- Need S |

```
    ...
  }
```

It should be noted that in the context of the present disclosure, the term “legacy UE” may refer to a UE that is implemented before the specification including the NES function, or a UE that does not support the NES function.

In some implementations, in a case that the network indicates the common network configuration(s) to the UEs, legacy UE(s) within the cell may not successfully receive the indication from the network. To minimize potential adverse effects on the legacy UEs, several mitigation methods may be employed.

Two example implementations of the mitigation methods (e.g., method A and method B) are described below.

### Method A

It should be noted that in the context of the present disclosure, the term “NES cell” may refer to an alternative type of Non-Public Network (NPN) cell, specifically designed to cater to the UEs equipped with the NES functionality.

An NES cell may possess an NES ID (e.g., NES-IdentityInfoList), which may be carried in an RRC IE (e.g., CellAccessRelatedInfo) within SIB1.

The IE CellAccessRelatedInfo in TS 38.331, as shown in Table 5 below, may be used to indicate cell access related information for the corresponding cell.

TABLE 5

| | |
|---|---|
| CellAccessRelatedInfo ::= | SEQUENCE { |
| plmn-Identity InfoList | PLMN-IdentityInfoList, |
| cellReservedForOtherUse | ENUMERATED {true} OPTIONAL, -- Need R |

```
    ...,
    [[
```

| | |
|---|---|
| cellReservedForFutureUse-r16 | ENUMERATED {true} OPTIONAL, -- Need R |
| npn-IdentityInfoList-r16 | NPN-IdentityInfoList-r16 OPTIONAL -- Need R |

```
    ]],
    [[
```

| | |
|---|---|
| snpn-AccessInfoList-r17 | SEQUENCE (SIZE (1..maxNPN-r16)) OF SNPN-AccessInfo-r17 |

```
  OPTIONAL -- Need R
    ]]
      }
```

In some implementations, the NES-IdentityInfoList may be used to configure a set of the NES-IdentityInfo elements. Each element in this set may include a list of one or more NES identities, and the associated information.

For example, the NES-IdentityInfoList may be regarded as an identity of a network equipped with the NES functionality. For a UE that is compliant with the NES release version, or any higher version that supports the NES functionality (e.g., a non-legacy UE, which may also be referred to as NES UE in the present disclosure), recognition of the NES-IdentityInfoList in the CellAccessRelatedInfo is crucial. In a case that the IE is recognized and the cellReservedForOtherUse is set to true, the UE may subscribe to the NES cell. Otherwise, the UE may be barred from accessing the NES cell.

Since the legacy UEs could not recognize the NES-IdentityInfoList, the network may use a cell-specific information or use other common signaling methods to notify the legacy UEs about the identity of the network with the NES functionality (e.g., for a duration ranging from zero to an indefinite period).

In some implementations, a unified access control, for both NES UE and legacy UE, to access an NES network (e.g., cell) may be adopted. Specifically, a new Access Categories IE (e.g., NES (Access) category ranging from 32 to 63) may be defined and configured by the operator. Additionally, a new Access Identity IE (e.g., NES (Access) Identity ranging from 4 to 10) may be defined for the UEs with NES functionality. When a UE transitions from the RRC Idle mode to an RRC Connected mode to connect to a BS equipped with the NES functionality, the UE may be required to conduct access control checks based on the new Access Identity IE and the new NES Category IE, for example, to assess the UE's access eligibility.

In some implementations, Table 4.5.2.1 of TS24.501, reproduced as shown in Table 6 below, may be adopted for the new Access Identity IE, for example, by using the access identity numbers 4 to 10.

TABLE 6

| Access Identity | |
|---|---|
| number | UE configuration |
| 0 | UE is not configured with any parameters from this table |
| 1 (NOTE 1) | UE is configured for multimedia priority service (MPS). |
| 2 (NOTE 2) | UE is configured for mission critical service (MCS). |
| 3 (NOTE 4) | UE for which a disaster condition applies |
| 4-10 | Reserved for future use |
| 11 (NOTE 3) | Access Class 11 is configured in the UE. |
| 12 (NOTE 3) | Access Class 12 is configured in the UE. |
| 13 (NOTE 3) | Access Class 13 is configured in the UE. |
| 14 (NOTE 3) | Access Class 14 is configured in the UE. |
| 15 (NOTE 3) | Access Class 15 is configured in the UE. |

In some implementations, Table 4.5.2.2 of TS 24.501, reproduced as Table 7 below, may be adopted for the new Access Categories IE, for example, by using the rule #3.

TABLE 7

| | Type of | Requirements | Access |
|---|---|---|---|
| Rule # | access attempt | to be met | Category |
| 1 | Response to paging or | Access attempt is for MT access, or | 0 (=MT_acc) |
| | NOTIFICATION over non- | handover of ongoing MMTEL voice | |
| | 3GPP access; | call, MMTEL video call or SMSoIP | |
| | 5GMM connection | from non-3GPP access; or | |
| | management procedure initiated | Access attempt is made upon receipt | |
| | for the purpose of transporting | of “call-pull-initiated” (3GPP TS | |
| | an LPP message without an | 24.174 [13D]) | |
| | ongoing 5GC-MO-LR | | |
| | procedure; | | |
| | Access attempt to handover of | | |
| | ongoing MMTEL voice call, | | |
| | MMTEL video call or SMSoIP | | |
| | from non-3GPP access; or | | |
| | Access attempt upon receipt of | | |
| | “call-pull-initiated” indication | | |
| | from the upper layers (see | | |
| | 3GPP TS 24.174 [13D]) | | |
| 2 | Emergency | UE is attempting access for an | 2 (=emergency) |
| | | emergency session (NOTE 1, NOTE | |
| | | 2) | |
| 3 | Access attempt for operator- | UE stores operator-defined access | 32-63 (=based on |
| | defined access category | category definitions valid in the | operator |
| | | current PLMN as specified in | classification) |
| | | subclause 4.5.3, and access attempt is | |
| | | matching criteria of an operator- | |
| | | defined access category definition | |
| 3.1 | Access attempt for MO | UE is in NB-NI mode and allowed to | 10 (=MO |
| | exception data | use exception data reporting (see the | exception data) |
| | | Exception DataReportingAllowed leaf | |
| | | of the NAS configuration MO in | |
| | | 3GPP TS 24.368 [17] or the USIM | |
| | | file EF_{NASCONFIG} in 3GPP TS 31.102 | |
| | | [22]), and access attempt is for MO | |
| | | data or for MO signalling initiated | |
| | | upon receiving a request from upper | |
| | | layers to transmit user data related to | |
| | | an exceptional event. | |
| 4 | Access attempt for delay | (a)UE is configured for NAS | 1 (=delay |
| | tolerant service | signalling low priority or UE | tolerant) |
| | | supporting S1 mode is configured for | |
| | | EAB (see the | |
| | | “ExtendedAccessBarring” leaf of | |
| | | NAS configuration MO in 3GPP TS | |
| | | 24.368 [17] or 3GPP TS 31.102 [22]) | |
| | | where “EAB override” does not apply, | |
| | | and | |
| | | (b): the UE received one of the | |
| | | categories a, b or c as part of the | |
| | | parameters for unified access control | |
| | | in the broadcast system information, | |
| | | and the UE is a member of the | |
| | | broadcasted category in the selected | |
| | | PLMN or RPLMN/equivalent PLMN | |
| | | (NOTE 3, NOTE 5, NOTE 6, NOTE | |
| | | 7, NOTE 8) | |
| 5 | MO MMTel voice call; or | Access attempt is for MO MMTel | 4 (=MO |
| | MT MMTel voice call | voice call or MT MMTel voice call | MMTel voice) |
| | | or for NAS signalling connection | |
| | | recovery during ongoing MO MMTel | |
| | | voice call or ongoing MT MMTel | |
| | | voice call (NOTE 2) | |
| 6 | MO MMTel video call; or | Access attempt is for MO MMTel | 5 (=MO |
| | MT MMTel video call | video call or MT MMTel video call | MMTel video) |
| | | or for NAS signalling connection | |
| | | recovery during ongoing MO MMTel | |
| | | video call or ongoing MT MMTel | |
| | | video call (NOTE 2) | |
| 7 | MO SMS over NAS or MO | Access attempt is for MO SMS over | 6 (=MO SMS |
| | SMSoIP; or | NAS (NOTE 4) or MO SMS over | and SMSoIP) |
| | MT SMSoIP | SMSoIP transfer or MT SMS over | |
| | | SMSoIP | |
| | | or for NAS signalling connection | |
| | | recovery during ongoing MO SMS or | |
| | | SMSoIP transfer or ongoing MT | |
| | | MMTel video call (NOTE 2) | |
| 7.1 | MO IMS registration related | Access attempt is for MO IMS | 9 (=MO IMS |
| | signalling | registration related signalling (e.g. | registration |
| | | IMS initial registration, re- | related |
| | | registration, subscription refresh) | signalling) |
| | | or for NAS signalling connection | |
| | | recovery during ongoing procedure | |
| | | for MO IMS registration related | |
| | | signalling (NOTE 2a) | |
| 8 | UE NAS initiated 5GMM | Access attempt is for MO signalling | 3 (=MO_sig) |
| | specific procedures | | |
| 8.1 | Mobile originated location | Access attempt is for mobile | 3 (=MO_sig) |
| | request | originated location request (NOTE 9) | |
| 8.2 | Mobile originated signalling | Access attempt is for mobile | 3 (=MO_sig) |
| | transaction towards the PCF | originated signalling transaction | |
| | | towards the PCF (NOTE 10) | |
| 9 | UE NAS initiated 5GMM | Access attempt is for MO data | 7 (=MO_data) |
| | connection management | | |
| | procedure or 5GMM NAS | | |
| | transport procedure | | |
| 10 | An uplink user data packet is to | No further requirement is to be met | 7 (=MO_data) |
| | be sent for a PDU session with | | |
| | suspended user-plane resources | | |

### Method B

Even if a UE does not support the NES function, the UE may still report the UE capability or the UE Assistance Information (UAI) to the network. Regarding the UE capability, a new IE (e.g., NES-Parameters-r18) may be defined and described in the Regular non-critical Rel-XX extension IEs. The new IE (e.g., NES-Parameters-r18) may be defined as an indicator of the UE's capacity to support or not support the NES function.

In some implementations, the network may use handover instruction(s) to guide the legacy UE(s) towards other cells, based on the aforementioned UE information (e.g., UE capability or UAI).

In some implementations, the network may transition the legacy UE(s) from a connected state to an idle state for performing the cell selection procedure.

### IV. Activation of the NES Function

The method for activating the NES function is also crucial. NES may be viewed as a network state. While some networks may be equipped to offer NES functionalities, they may not necessarily be in the NES state. Thus, identifying an effective activation method is key to leveraging the NES function.

The NES function may be applicable to the network and/or the UE. On the UE side, the UEs operating with the NES function may be aligned based on parameters, such as an offset, cycle, and an active time, as illustrated by the first UE and the second UE in FIG. 2. On the network side, the implementation of the offset, cycle, and the active time may be introduced and implemented for the purpose of network power saving, as illustrated by the BS in FIG. 2.

In some implementations, the activation of the NES function on the UE side may be triggered through the reception of RRC/MAC/DCI.

In some implementations, the activation may occur upon receiving a MAC CE. When a UE receives a MAC CE that activates the NES function, both the network and the UE may then be considered to be in the NES state. Conversely, if a UE within a cell does not receive the MAC CE that activates the NES function, the UE may be considered to be not in the NES state.

In some implementations, the UE may receive a MAC CE that deactivates the NES function. As such, neither the network nor the UE may be considered to be in the NES function state.

In some implementations, the MAC CE may include a specific bit that indicates the activation/deactivation of the NES function: a value of 1 signifies activation, while a value of 0 signifies deactivation of the NES function.

In some implementations, the MAC CE may be a Cell-DX Command MAC CE. The Logical Channel ID (LCID) for the Cell-DX Command MAC CE may range from 35 to 46. If a Cell-DX Command MAC CE is received through a PDSCH scheduled by the DCI with CRC scrambled by the C-RNTI for unicast transmission, the UE may activate or deactivate the NES function for a certain DRX group.

In some implementations, the certain DRX group may be explicitly indicated by the Cell-DX Command MAC CE. Indexing or bitmapping may be used as a NES DRX group indication to indicate the NES DRX group.

In some implementations, the certain DRX group may be determined as the DRX group that includes the serving cell where the Cell-DX Command MAC CE was received.

In some implementations, Table 6.2.1-1 of TS 38.321, reproduced as shown in Table 8 below, lists values of LCID for DL-SCH, in which the codepoint/index 35 to 46 may be adopted for the LCID for the Cell-DX Command MAC CE.

TABLE 8

| Codepoint/Index | LCID values |
|---|---|
| 0 | CCCH |
| 1-32 | Identity of the logical channel of DCCH, DTCH and multicast MTCH |
| 33 | Extended logical channel ID field (two-octet eLCID field) |
| 34 | Extended logical channel ID field (one-octet eLCID field) |
| 35-46 | Reserved |
| 47 | Recommended bit rate |
| 48 | SP ZP CSI-RS Resource Set Activation/Deactivation |
| 49 | PUCCH spatial relation Activation/Deactivation |
| 50 | SP SRS Activation/Deactivation |
| 51 | SP CSI reporting on PUCCH Activation/Deactivation |
| 52 | TCI State Indication for UE-specific PDCCH |
| 53 | TCI States Activation/Deactivation for UE-specific PDSCH |
| 54 | Aperiodic CSI Trigger State Subselection |
| 55 | SP CSI-RS/CSI-IM Resource Set Activation/Deactivation |
| 56 | Duplication Activation/Deactivation |
| 57 | SCell Activation/Deactivation (four octets) |
| 58 | SCell Activation/Deactivation (one octet) |
| 59 | Long DRX Command |
| 60 | DRX Command |
| 61 | Timing Advance Command |
| 62 | UE Contention Resolution Identity |
| 63 | Padding |

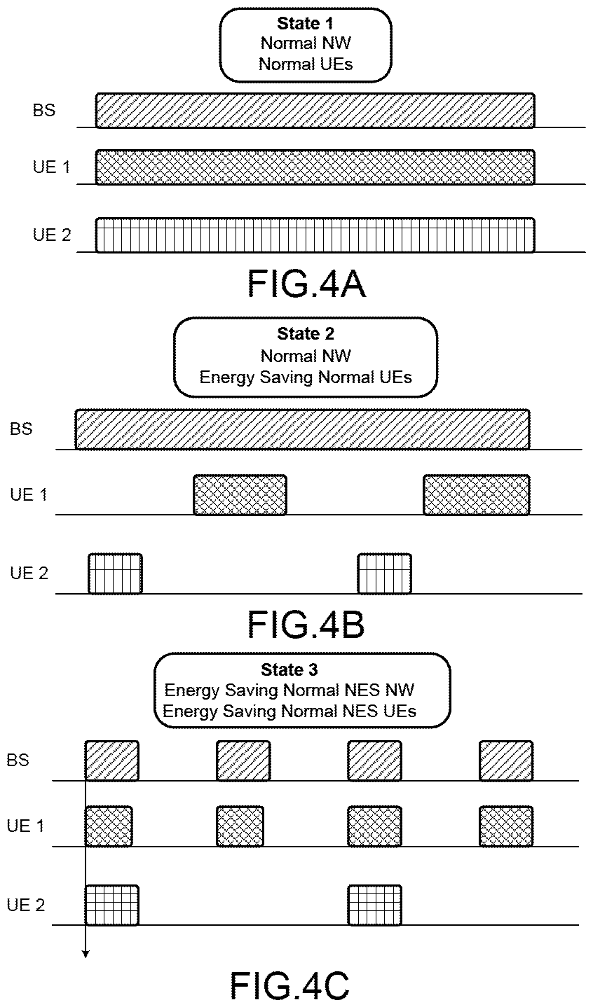

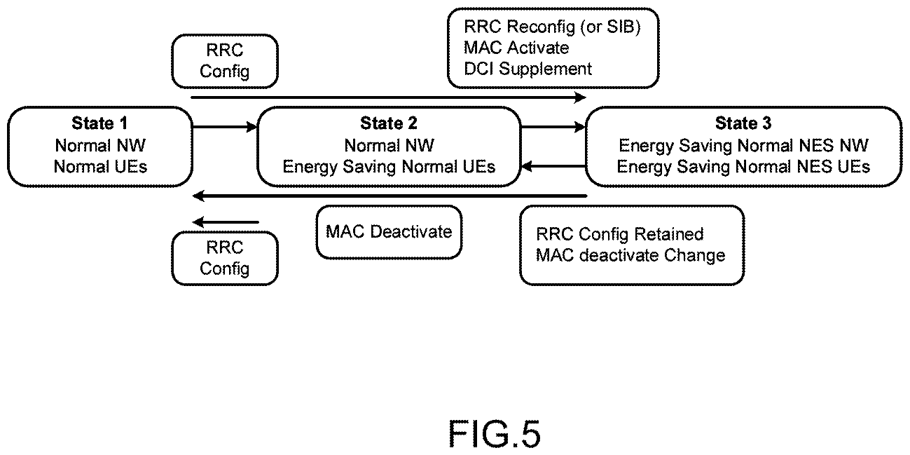

FIGS. 4A, 4B, and 4C are schematic diagrams illustrating different states, according to an example implementation of the present disclosure. FIG. 5 is a schematic diagram illustrating state transition, according to an example implementation of the present disclosure.

It should be noted that in the present disclosure, a normal network (NW) may refer to a network in which the NES functionality is not activated; a normal UE may refer to a UE on which the DRX functionality (e.g., outlined in Release 15) and the NES functionality are not activated; an energy saving normal UE may refer to a UE on which the DRX functionality is activated while the NES functionality is not activated; an energy saving NES NW may refer to a network on which the NES functionality is activated; and an energy saving NES UE may refer to a UE on which the NES functionality is activated.

Referring to FIGS. 4A, 4B, and 4C, the active times of a BS, a first UE (e.g., UE 1), and a second UE (e.g., UE 2) are illustrated. State 1 is illustrated in FIG. 4A, in which a normal NW and normal UE(s) may be present. State 2 is illustrated in FIG. 4B, in which a normal NW and energy saving normal UE(s) may be present. State 3 is illustrated in FIG. 4C, in which an energy saving NES NW and energy saving NES UE(s) may be present.

Referring to FIG. 5, the transition from State 1 to State 2 may be defined by the C-DRX specifications outlined in 3GPP TS 38.321 V15.0.0.

Referring to FIG. 5, in some implementations, to transition from State 2 or State 1 to State 3, the network may use the RRC signaling (e.g., through the DRX-config-NES) to align the pattern(s) of the UE(s) and to inform the UE(s) of the pattern of the network. Additionally, the network may activate the NES function of the UE(s) by using Cell-DX Command MAC CE.

Referring to FIG. 5, in some implementations, to transition from State 3 back to State 1, the network may deactivate the NES functionality of UE(s) by using the Cell-DX Command MAC CE. In this case, the energy saving NES network may fall back to a normal network, and the energy saving NES UE(s) may fall back to normal UE(s).

Referring to FIG. 5, in some implementations, to transition from State 3 to State 2, the network may utilize the Cell-DX Command MAC CE with an additional specific bit to indicate that the energy saving NES network is falling back to a normal network and that the energy saving NES UE(s) may fall back to energy saving normal UE(s).

In some implementations, the RRC configurations, such as DRX-config, of the UE(s) in State 2 within the same cell may be retained when transitioning from State 2 to State 3.

In some implementations, when transitioning from State 3 to State 2, the network may indicate a change in the RRC configuration(s) from DRX-config-NES back to DRX-config (e.g., previously retained) using (indication(s) in) DCI, MAC, or RRC signals.

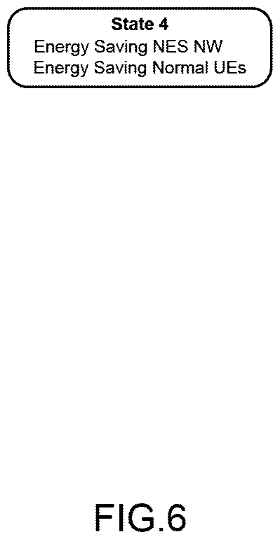

FIG. 6 is a schematic diagram illustrating a state, according to an example implementation of the present disclosure.

In some implementations, regarding the integration of legacy UEs into the energy saving NES network, State 4 may be presented as shown in FIG. 6, in which the energy saving NES network and the energy saving normal UE(s) may be present. In this case, the network may reconfigure the legacy UEs with the DRX-config.

### V. UE Awareness of Cell DRX/DTX Active Periods

Cell DRX/DTX active periods may affect the downlink and uplink transmission behaviors of the UE. Consequently, it becomes essential for the UEs to understand how to adjust their corresponding behaviors effectively, for example, based on the configurations of the Cell DRX/DTX.

The network may use RRC signaling (e.g., through DRX-config-NES) to align the patterns of the UEs. The DRX-config-NES RRC message is transmitted upon the resource granted via the DCI with CRC scrambled by the C-RNTI may be received and the corresponding configuration will be activated by the Cell-DX Command MAC CE. Consequently, the UE may adopt the DRX pattern outlined in the DRX-config-NES.

In some implementations, the UE's traffic data e.g., burst profile may change after being configured the DRX pattern. In this case, the network may perform adaption toward the DRX pattern by using either the DCI, MAC, or RRC signaling.

In some implementations, an indicator within the DCI format 2_6 (e.g., nes-switching) may be served as an index to a specific pattern with regard to the burst.

In some implementations, more than one DRX-config-NES may be configured for a single UE, where each DRX-config-NES may be used to configure a DRX pattern and may be associated with a distinct DRX configuration ID.

For example, two DRX-config-NES associated with a first configuration ID and a second configuration ID may be configured to a UE. When the UE monitors the PDCCH based on a DRX-config-NES associated with the first DRX configuration ID, the UE may monitor the DCI format 2_6 outside the active time of the DRX pattern defined by the DRX-config associated with first DRX configuration ID. In a case that the UE detects the DCI format 2_6 including an indication that indicates the second DRX configuration ID, the UE may switch the PDCCH monitoring to be based on the DRX-config-NES associated with the second DRX configuration ID.

For uplink (UL) configured grant (CG) transmissions, it is essential that the UL CG transmissions occur during active time of the cell-DX. Therefore, maintaining the cell-DX pattern at the UE side may be necessary.

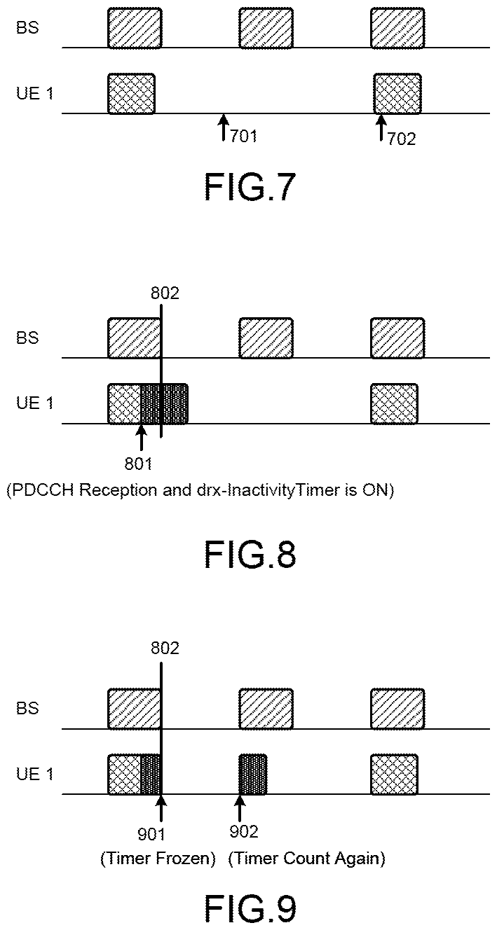

FIG. 7 is a schematic diagram illustrating an adjustment of configured grant (CG) uplink (UL) transmissions, according to an example implementation of the present disclosure.

Referring to FIG. 7, the active times of a BS and a first UE (e.g., UE 1) are illustrated. The first UE may determine whether to perform CG UL transmissions based on the cell-DX pattern (e.g., the active time) of the BS.

For example, a CG UL transmission may be configured at a first time indicated by arrow 701. Based on the cell-DX pattern, the first UE may determine that the first time is outside the active time of the BS and forgo performing the CG UL transmission at the first time. The first UE may, based on the cell-DX pattern, further determine to perform the CG UL transmission at a second time indicated by arrow 702, which is inside the active time of the BS.

For a UE receiving the PDCCH and new data transmission in an energy saving NES network, the DRX inactivity timer (e.g., drx-Inactivity Timer) for the UE may be re-designed.

FIGS. 8 and 9 are schematic diagrams illustrating redesigning a discontinuous reception inactivity timer, according to an example implementation of the present disclosure.

The drx-Inactivity Timer specifies a duration following a PDCCH occasion, during which the PDCCH may indicate a new UL, DL, or sidelink (SL) transmission for the MAC entity. Referring to FIG. 8, the drx-Inactivity Timer may start at a first time indicated by arrow 801 and may become irrelevant if the drx-InactivityTimer extends beyond the vertical line 802, a period during which no reception may occur by the BS. Since the UE may be informed of the cell-DX pattern of the BS, for example through the above discussed method, the UE may re-design the timer.

Referring to FIG. 9, in some implementations, the UE may pause or suspend the timer at a second time indicated by arrow 901. During this suspension, the process buffer may also be paused, and its status may be preserved and stored. Upon the arrival of the next cell-DX active time, the timer may resume or restart (e.g., at a third time indicated by arrow 902), alongside the reactivation of the corresponding process buffer.

In some implementations, the UE may stop the timer directly at the second time indicated by arrow 901.

For a UE receiving the PDSCH and the corresponding decode is not correct in an energy saving NES network, the drx-RetransmissionTimerDL for that UE may be re-designed.

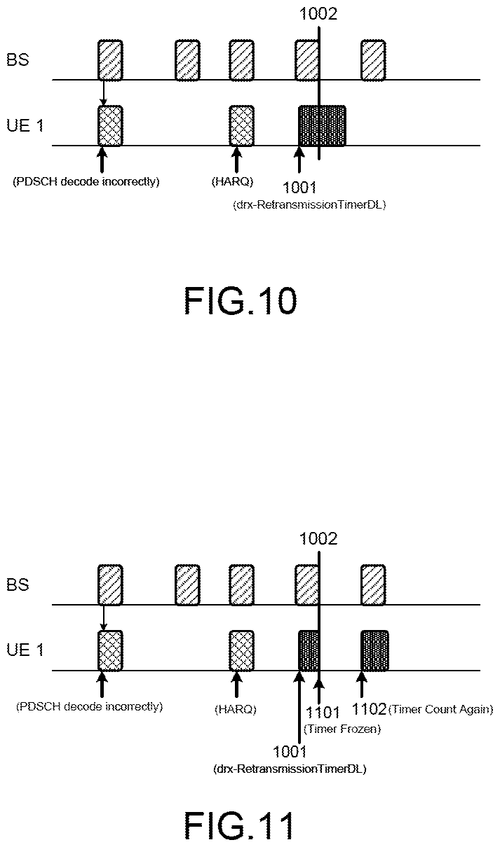

FIGS. 10 and 11 are schematic diagrams illustrating redesigning a discontinuous reception retransmission timer for downlink, according to an example implementation of the present disclosure.

Referring to FIG. 10, after a UE receives a PDSCH and decodes the PDSCH incorrectly, the UE may send a HARQ feedback to the BS. Following a duration specified by the drx-HARQ-RTT-Time-DL, the UE may anticipate a retransmission from the BS, and may start the drx-RetransmissionTimerDL to stay active. The drx-RetransmissionTimerDL may be applicable to each DL HARQ process except for broadcast processes, and may denote a maximum duration within which a DL retransmission is expected to be received. The drx-RetransmissionTimerDL may start at a first time indicated by arrow 1001 and become irrelevant if the drx-RetransmissionTimerDL extends beyond the vertical line 1002, a period during which no BS transmissions may occur. Since the UE may be informed with the cell-DX pattern of the BS, through the previously mentioned method, the UE may re-design the timer.

Referring to FIG. 11, in some implementations, the UE may pause or suspend the timer at a second time indicated by arrow 1101. During this suspension, the process buffer may also be paused, and its status may be preserved and stored. Upon the arrival of the next cell-DX active time, the timer may resume or restart (e.g., at a third time indicated by arrow 1102), alongside the reactivation of the corresponding process buffer.

In some implementations, the UE may stop the timer directly at the second time indicated by arrow 1101.

For a UE receiving a UL grant and the corresponding transmission is not correct in an energy saving NES network, the drx-RetransmissiontimerUL for the UE may be re-designed.

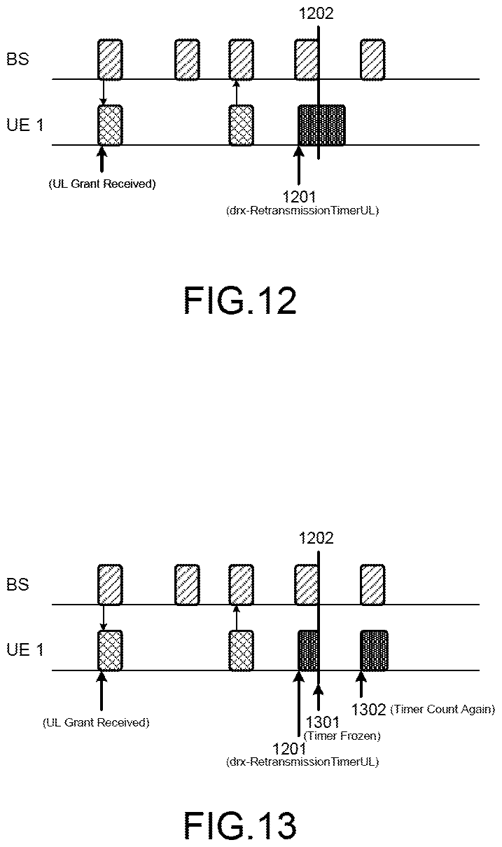

FIGS. 12 and 13 are schematic diagrams illustrating redesigning a discontinuous reception retransmission timer for uplink, according to an example implementation of the present disclosure.

Referring to FIG. 12, the drx-RetransmissionTimerUL may start at a first time indicated by arrow 1201 and become irrelevant if the drx-RetransmissionTimerUL extends beyond the vertical line 1202, a period during which no BS transmissions may occur. Since the UE may be informed with the cell-DX pattern of the BS, through the previously mentioned method, the UE may re-design the timer.

Referring to FIG. 13, in some implementations, the UE may pause or suspend the timer at a second time indicated by arrow 1301. During this suspension, the process buffer may also be paused, and its status may be preserved and stored. Upon the arrival of the next cell-DX active time, the timer may resume or restart (e.g., at a third time indicated by arrow 1302), alongside the reactivation of the corresponding process buffer.

In some implementations, the UE may stop the timer directly at the second time indicated by arrow 1301.

Other C-DRX timers outlined in TS 38.331, such as the drx-Retransmission TimerSL-r17 within the DRX-ConfigSL, may also be modified or redesigned using the aforementioned method due to the occurrence of cell DTX/DRX.

In some implementations, a UE may maintain multiple DRX-config-NES configurations (e.g., in scenarios such as cross-carrier scheduling). When a cell is scheduled to serve the UE, the UE may be configured with the cell-DX offset, the cell-DX cycle, and the cell-DX active time in the DRX-config-NES corresponding to the scheduled cell, to adapt the uplink and downlink transmission patterns of the scheduled cell.

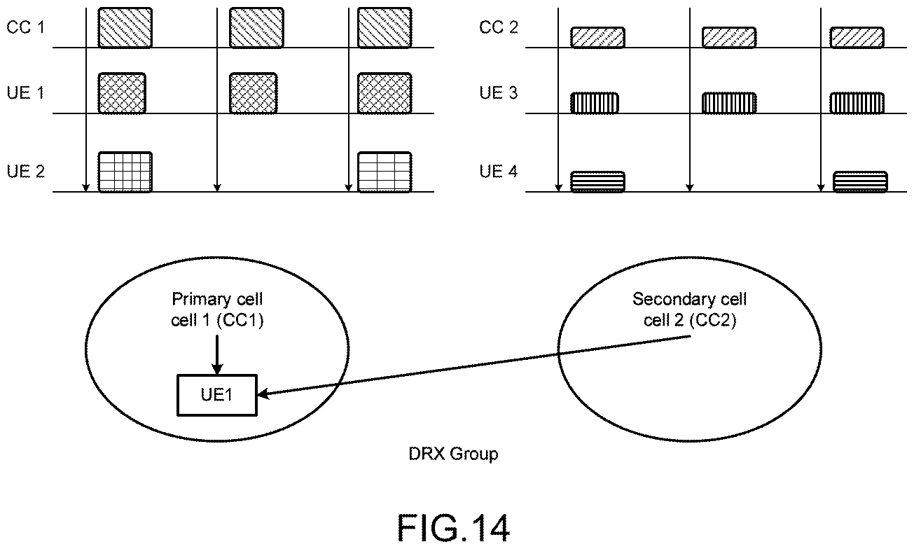

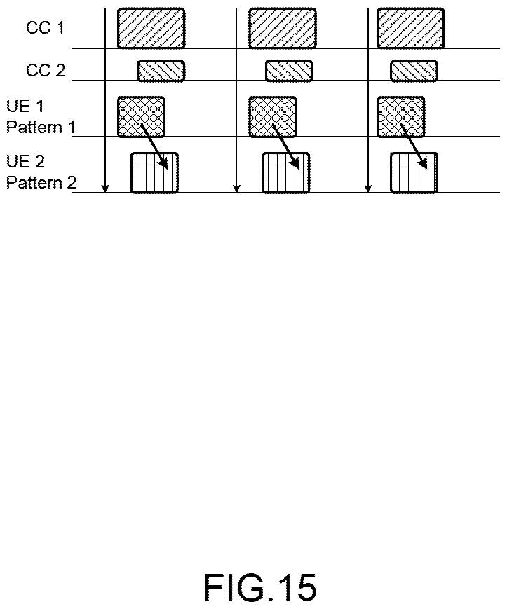

FIG. 14 is a schematic diagram illustrating a network energy saving function of two cells, according to an example implementation of the present disclosure. FIG. 15 is a schematic diagram illustrating switching discontinuous reception patterns, according to an example implementation of the present disclosure.

Referring to FIG. 14, two cells including a first cell (e.g., CC1) and a second cell (e.g., CC2) may be in a DRX group. A first UE (e.g., UE 1) and a second UE may be associated with the first cell, and a third UE (e.g., UE 3) and a fourth UE (e.g., UE 4) may be associated with the second cell. The active times of the first and second cells, and the first to fourth UEs are illustrated in the blocks shown in FIG. 14.

The NES function may be activated independently in both of the first cell and the second cell. Specifically, the first cell may implement a pattern (e.g., as illustrated in the blocks of CC1) that is determined based on the patterns of the first UE (e.g., as illustrated in the blocks of UE 1) and the second UE (e.g., as illustrated in the blocks of UE2). Similarly, the second cell may implement a pattern (e.g., as illustrated in the blocks of CC2) that is determined based on the patterns of the third UE (e.g., as illustrated in the blocks of UE 3) and the fourth UE (e.g., as illustrated in the blocks of UE 4).

In a case that the first UE is configured/associated with the first cell and the second cell, the first cell as the Primary Cell (PCell) and the second cell as the Secondary Cell (SCell), the DRX-config-NES RRC configurations applied by the first UE may be switched when a different serving cell is scheduling the first UE.

Referring to FIG. 15, a first DRX pattern for the first UE may be determined based on a first DRX-config-NES (e.g., as illustrated in the blocks of “UE 1 pattern 1”) when the first cell is scheduling the first UE. The first DRX pattern may then shift to a second DRX pattern based on a second DRX-config-NES (e.g., as illustrated in the blocks of “UE 1 pattern 2”) when the scheduling responsibilities transfer to the second cell, aligning the cell-DX pattern of the second cell (e.g., as illustrated in the blocks of CC2).

For a UE receiving PDCCH and new data transmission in an energy saving network while cross carrier scheduling is applied, the inactivity timer for that UE may be re-designed.

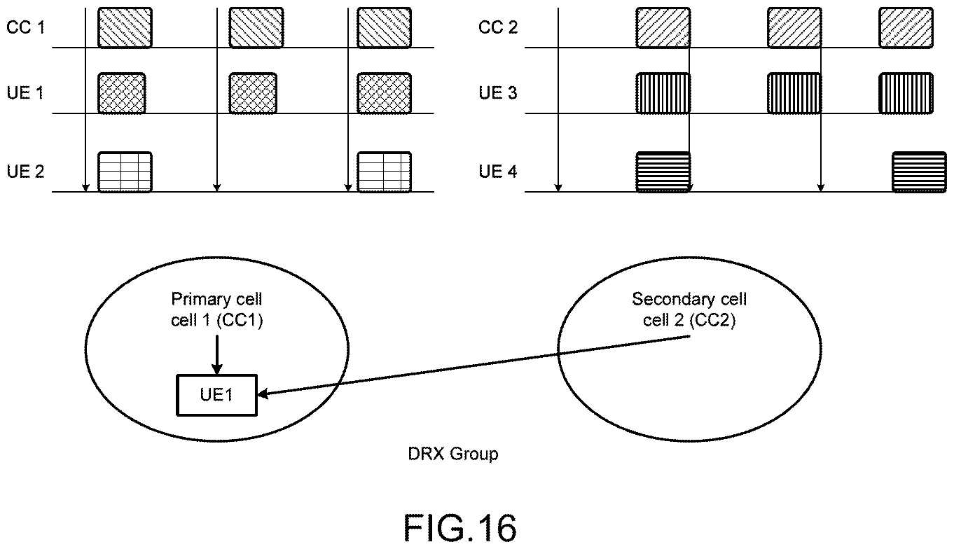

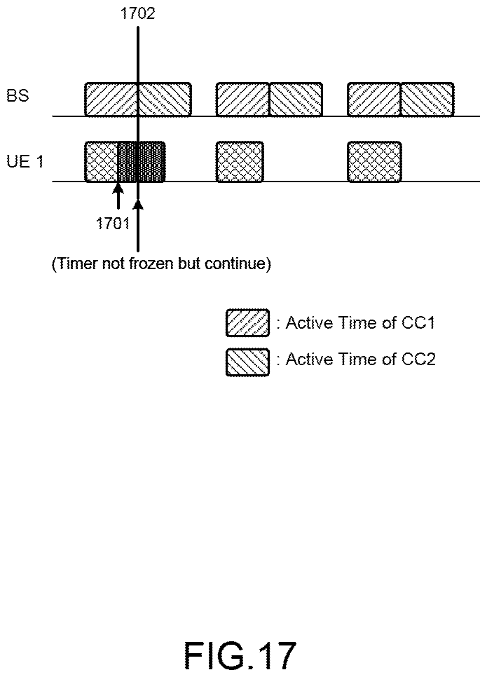

FIG. 16 is a schematic diagram illustrating a network energy saving function of two cells, according to an example implementation of the present disclosure. FIG. 17 is a schematic diagram illustrating a discontinuous reception inactivity timer, according to an example implementation of the present disclosure.

Referring to FIG. 16, two cells including a first cell (e.g., CC1) and a second cell (e.g., CC2) may be in a DRX group. A first UE (e.g., UE 1) and a second UE may be associated with the first cell, and a third UE (e.g., UE 3) and a fourth UE (e.g., UE 4) may be associated with the second cell. The active times of the first and second cells, and the first to fourth UEs are illustrated in the blocks shown in FIG. 16.

The NES function may be activated independently in both of the first cell and the second cell. Specifically, the first cell may implement a pattern (e.g., as illustrated in the blocks of CC1) that is determined based on the patterns of the first UE (e.g., as illustrated in the blocks of UE 1) and the second UE (e.g., as illustrated in the blocks of UE2). Similarly, the second cell may implement a pattern (e.g., as illustrated in the blocks of CC2) that is determined based on the patterns of the third UE (e.g., as illustrated in the blocks of UE 3) and the fourth UE (e.g., as illustrated in the blocks of UE 4).

In a case that the first UE is configured/associated with the first cell and the second cell, the first cell as the PCell and the second cell as the SCell, the DRX-config-NES RRC configurations applied by the first UE may be switched when a different serving cell is scheduling the first UE.

Referring to FIGS. 16 and 17, in some implementations, the drx-InactivityTimer that starts at a first time indicated by arrow 1701 when new transmission arrives may continue even if the drx-Inactivity Timer extends beyond the vertical line 1702 since the first UE is continued to be scheduled by the second cell beyond the vertical line 1702.

The mechanisms described above are designed for application in both NR-RAN and E-UTRAN networks. Specifically, the mechanisms may be implemented in eNBs within the E-UTRAN and gNBs in the NR-RAN. Additionally, the mechanisms may be implemented in both Terrestrial Network (TN) and Non-Terrestrial Network (NTN) cells, as well as for UEs operating within NTN and TN access networks. The DRX mechanisms described in the present disclosure may include the Connected-DRX mechanism in LTE/NR Uu interface, and/or sidelink DRX mechanisms in NR/E-UTRA PC5 interface.

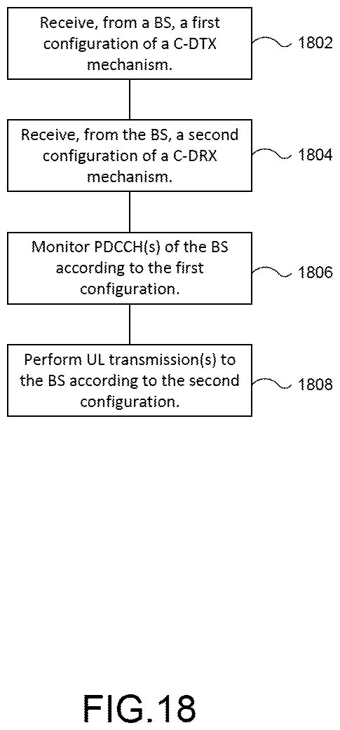

FIG. 18 is a flowchart for a method of performing a network energy saving function, according to an example implementation of the present disclosure. It should be noted that although actions 1802, 1804, 1806 and 1808 are illustrated as separate actions, represented as independent blocks, in FIG. 18, these separately illustrated actions should not be construed as necessarily order-dependent. The order in which the actions are performed in FIG. 18 is not intended to be construed as a limitation, and any number of the disclosed blocks may be combined in any order to implement the method, or an alternate method. Moreover, each of actions 1802, 1804, 1806 and 1808 may be performed independently of other actions and may be omitted in some implementations of the present disclosure.

In action 1802, the UE may receive, from the BS, a first configuration of a cell-discontinuous transmission (C-DTX) mechanism. In action 1804, the UE may receive, from the BS, a second configuration of a cell-discontinuous reception (C-DRX) mechanism.

Specifically, the UE may receive the configurations of the cell-DX from a BS that is equipped with the NES function. The cell-DX may include the C-DTX and the C-DRX, and the received configurations of the cell-DX may include the first configuration of the C-DTX indicating at least one discontinuous pattern of active times for transmission, and the second configuration of the C-DRX indicating at least one discontinuous pattern of active times for reception.

In some implementations, the first configuration may include more than one pattern. For example, the first configuration may include a first discontinuous pattern and a second discontinuous pattern.

In some implementations, the second configuration may include more than one pattern as well. For example, the second configuration may include a third discontinuous pattern and a fourth discontinuous pattern.

In action 1806, the UE may monitor the PDCCH(s) of the BS according to the first configuration. In action 1808, the UE may perform uplink transmission(s) to the BS according to the second configuration.

Specifically, the first configuration may indicate the active time(s) of the BS for transmission(s), and the second configuration may indicate the active time(s) of the BS for reception(s). Therefore, once the UE is informed of the first configuration and the second configuration, the UE may monitor the PDCCH(s) of the BS according to the first configuration, and perform uplink transmission(s) to the BS according to the second configuration.

For example, the UE may monitor the PDCCH(s) of the BS in the active time(s) of the C-DTX mechanism. For example, the UE may perform uplink transmission(s), such as sending a scheduling request (SR) to the BS in the active time(s) of the C-DRX mechanism.

In some implementations, the BS may inform the UE in advance that the BS is configured/equipped with the NES function. Specifically, the BS may indicate that the BS is configured with the cell-DTX mechanism and/or the cell-DRX mechanism to the UE through an indication (e.g., a parameter, an IE, etc.) carried in DCI, MAC, or RRC signalling.

In some implementations, the first configuration may include at least a first discontinuous pattern and a second discontinuous pattern. In this case, the UE may select, based on a specific indication received from the BS, one of the first discontinuous pattern and the second discontinuous pattern for monitoring PDCCH(s) (e.g., from the BS) using the selected one of the first discontinuous pattern and the second discontinuous pattern.

The specific indication may be, for example, an indication related to a cell (re)selection.

The specific indication may be, for example, carried in the DCI, MAC, or RRC signalling.

In some implementations, the second configuration may include at least a third discontinuous pattern and a fourth discontinuous pattern. In this case, the UE may select, based on a specific indication received from the BS, one of the third discontinuous pattern and the fourth discontinuous pattern for performing uplink transmission(s) (e.g., to the BS) using the selected one of the third discontinuous pattern and the fourth discontinuous pattern.

The specific indication may be, for example, an indication related to a cell (re)selection.

The specific indication may be, for example, carried in the DCI, MAC, or RRC signalling.

It should be noted that in the present disclosure, the BS may perform methods/actions corresponding to those performed by the UE. For example, the receiving actions performed by the UE may correspond to the transmitting/configuring actions of the BS; the transmitting actions performed by the UE may correspond to the receiving actions of the BS. That is, the BS and the UE may have reciprocally aligned roles in transmission and reception. Consequently, the methods or actions executed by the BS may be combined or integrated in a similar manner to how the methods or actions are executed by the UE.

For example, when viewed from the BS's perspective, method illustrated with reference to FIG. 18 may correspond to a method performed by the BS. Specifically, the BS may transmit a first configuration of a C-DTX mechanism to the UE, and may transmit PDCCH(s) to the UE according to the first configuration. Additionally, the BS may transmit a second configuration of a C-DRX mechanism to the UE, and may monitor/receive uplink transmission(s) from the UE according to the second configuration.

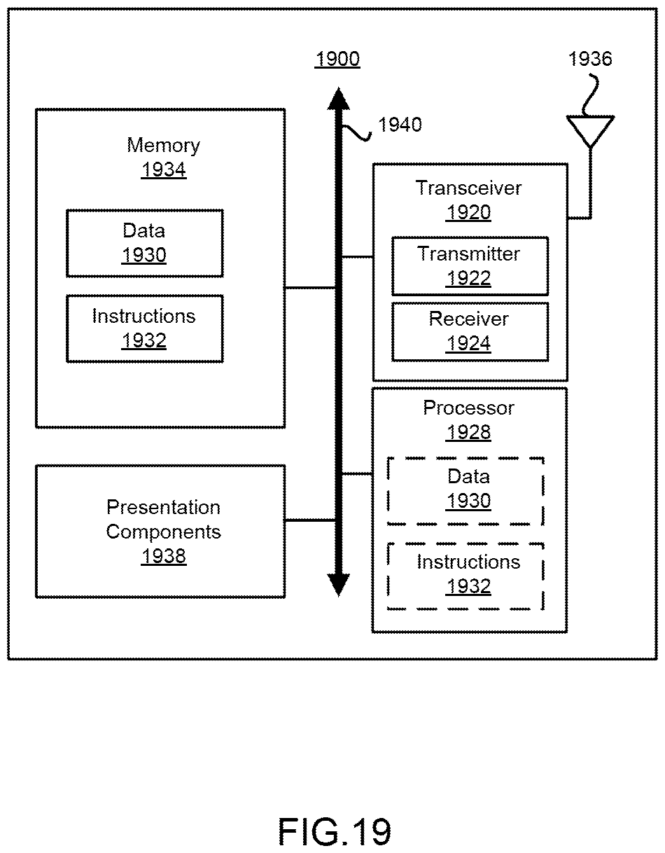

FIG. 19 is a block diagram illustrating a node 1900 for wireless communication, according to an example implementation of the present disclosure. As illustrated in FIG. 19, a node 1900 may include a transceiver 1920, a processor 1928, a memory 1934, one or more presentation components 1938, and at least one antenna 1936. The node 1900 may also include a radio frequency (RF) spectrum band module, a BS communications module, a NW communications module, and a system communications management module, Input/Output (I/O) ports, I/O components, and a power supply (not illustrated in FIG. 19).

Each of the components may directly or indirectly communicate with each other over one or more buses 1940. The node 1900 may be a UE or a BS that performs various functions disclosed with reference to FIGS. 1 through 18.

The transceiver 1920 has a transmitter 1922 (e.g., transmitting/transmission circuitry) and a receiver 1924 (e.g., receiving/reception circuitry) and may be configured to transmit and/or receive time and/or frequency resource partitioning information. The transceiver 1920 may be configured to transmit in different types of subframes and slots including, but not limited to, usable, non-usable and flexibly usable subframes and slot formats. The transceiver 1920 may be configured to receive data and control channels.

The node 1900 may include a variety of computer-readable media. Computer-readable media may be any available media that may be accessed by the node 1900 and include volatile (and/or non-volatile) media and removable (and/or non-removable) media.

The computer-readable media may include computer-storage media and communication media. Computer-storage media may include both volatile (and/or non-volatile media), and removable (and/or non-removable) media implemented in any method or technology for storage of information such as computer-readable instructions, data structures, program modules or data.

Computer-storage media may include RAM, ROM, EPROM, EEPROM, flash memory (or other memory technology), CD-ROM, Digital Versatile Disks (DVD) (or other optical disk storage), magnetic cassettes, magnetic tape, magnetic disk storage (or other magnetic storage devices), etc. Computer-storage media may not include a propagated data signal. Communication media may typically embody computer-readable instructions, data structures, program modules, or other data in a modulated data signal, such as a carrier wave, or other transport mechanisms and include any information delivery media.

The term “modulated data signal” may mean a signal that has one or more of its characteristics set or changed in such a manner as to encode information in the signal. Communication media may include wired media, such as a wired NW or direct-wired connection, and wireless media, such as acoustic, RF, infrared, and other wireless media. Combinations of any of the previously listed components should also be included within the scope of computer-readable media.

The memory 1934 may include computer-storage media in the form of volatile and/or non-volatile memory. The memory 1934 may be removable, non-removable, or a combination thereof. Example memory may include solid-state memory, hard drives, optical-disc drives, etc. As illustrated in FIG. 19, the memory 1934 may store a computer-readable and/or computer-executable instructions 1932 (e.g., software codes or programs) that are configured to, when executed, cause the processor 1928 to perform various functions disclosed herein, for example, with reference to FIGS. 1 through 18. Alternatively, the instructions 1932 may not be directly executable by the processor 1928 but may be configured to cause the node 1900 (e.g., when compiled and executed) to perform various functions disclosed herein.

The processor 1928 (e.g., having processing circuitry) may include an intelligent hardware device, e.g., a Central Processing Unit (CPU), a microcontroller, an ASIC, etc. The processor 1928 may include memory. The processor 1928 may process the data 1930 and the instructions 1932 received from the memory 1934, and information transmitted and received via the transceiver 1920, the baseband communications module, and/or the NW communications module. The processor 1928 may also process information to send to the transceiver 1920 for transmission via the antenna 1936 to the NW communications module for transmission to a Core Network (CN).

One or more presentation components 1938 may present data indications to a person or another device. Examples of presentation components 1938 may include a display device, a speaker, a printing component, a vibrating component, etc.

In view of the present disclosure, various techniques may be used for implementing the disclosed concepts without departing from the scope of those concepts. Moreover, while the concepts have been disclosed with specific reference to certain implementations, a person of ordinary skill in the art may recognize that changes may be made in form and detail without departing from the scope of those concepts. As such, the disclosed implementations are considered in all respects as illustrative and not restrictive. It should also be understood that the present disclosure is not limited to the specific implementations disclosed. Still, many rearrangements, modifications, and substitutions are possible without departing from the scope of the present disclosure.

What is claimed is:

1. A method performed by a user equipment (UE), the method comprising:
receiving, from a base station (BS), a first configuration of a cell-discontinuous transmission (cell-DTX) mechanism;
receiving, from the BS, a second configuration of a cell-discontinuous reception (cell-DRX) mechanism;
monitoring a physical downlink control channel (PDCCH) of the BS based on the first configuration; and
performing an uplink transmission to the BS based on the second configuration.

2. The method of claim 1, wherein the first configuration comprises a first discontinuous pattern and a second discontinuous pattern, and the method further comprises:
receiving, from the BS, an indication;
selecting, based on the indication, one of the first discontinuous pattern and the second discontinuous pattern; and
monitoring the PDCCH using the selected one of the first discontinuous pattern and the second discontinuous pattern.

3. The method of claim 1, wherein the second configuration comprises a first discontinuous pattern and a second discontinuous pattern, and the method further comprises:
receiving, from the BS, an indication;
selecting, based on the indication, one of the first discontinuous pattern and the second discontinuous pattern; and
performing the uplink transmission using the selected one of the first discontinuous pattern and the second discontinuous pattern.

4. The method of claim 1, further comprising:
receiving, from the BS, information related to whether the BS is configured with at least one of the cell-DTX mechanism and the cell-DRX mechanism.

5. The method of claim 4, wherein the information is carried in a radio resource control (RRC) parameter.

6. The method of claim 1, further comprising:
sending a scheduling request (SR) to the BS in an active time of the cell-DRX mechanism according to the second configuration.

7. A user equipment (UE), comprising:
one or more non-transitory computer-readable media storing one or more computer-executable instructions; and
at least one processor coupled to the one or more non-transitory computer-readable media, the at least one processor configured to execute the one or more computer-executable instructions to cause the UE to:
receive, from a base station (BS), a first configuration of a cell-discontinuous transmission (cell-DTX) mechanism;
receive, from the BS, a second configuration of a cell-discontinuous reception (cell-DRX) mechanism;
monitor a physical downlink control channel (PDCCH) of the BS based on the first configuration; and
perform an uplink transmission to the BS based on the second configuration.

8. The UE of claim 7, wherein the first configuration comprises a first discontinuous pattern and a second discontinuous pattern, and the at least one processor is configured to execute the computer-executable instructions to further cause the UE to:
receive, from the BS, an indication;
select, based on the indication, one of the first discontinuous pattern and the second discontinuous pattern; and
monitor the PDCCH using the selected one of the first discontinuous pattern and the second discontinuous pattern.

9. The UE of claim 7, wherein the second configuration comprises a first discontinuous pattern and a second discontinuous pattern, and the at least one processor is configured to execute the computer-executable instructions to further cause the UE to:
receive, from the BS, an indication;
select, based on the indication, one of the first discontinuous pattern and the second discontinuous pattern; and
perform the uplink transmission using the selected one of the first discontinuous pattern and the second discontinuous pattern.

10. The UE of claim 7, wherein the at least one processor is configured to execute the computer-executable instructions to further cause the UE to:
receive, from the BS, information related to whether the BS is configured with at least one of the cell-DTX mechanism and the cell-DRX mechanism.

11. The UE of claim 10, wherein the information is carried in a radio resource control (RRC) parameter.

12. The UE of claim 7, wherein the at least one processor is configured to execute the computer-executable instructions to further cause the UE to:
send a scheduling request (SR) to the BS in an active time of the cell-DRX mechanism according to the second configuration.

13. A base station (BS), comprising:
one or more non-transitory computer-readable media storing one or more computer-executable instructions; and
at least one processor coupled to the one or more non-transitory computer-readable media, the at least one processor configured to execute the one or more computer-executable instructions to cause the BS to:
transmit, to a user equipment (UE), a first configuration of a cell-discontinuous transmission (cell-DTX) mechanism;
transmit, to the UE, a second configuration of a cell-discontinuous reception (cell-DRX) mechanism;
transmit a physical downlink control channel (PDCCH), to the UE, based on the first configuration; and
receive an uplink transmission, from the UE, based on the second configuration.

14. The BS of claim 13, wherein the first configuration comprises a first discontinuous pattern and a second discontinuous pattern, and the at least one processor is configured to execute the computer-executable instructions to further cause the BS to:
transmit, to the UE, an indication, wherein the indication indicates one of the first discontinuous pattern and the second discontinuous pattern for the UE to monitor the PDCCH.

15. The BS of claim 13, wherein the second configuration comprises a first discontinuous pattern and a second discontinuous pattern, and the at least one processor is configured to execute the computer-executable instructions to further cause the BS to:
transmit, to the UE, an indication, wherein the indication indicates one of the first discontinuous pattern and the second discontinuous pattern for the UE to perform the uplink transmission.

16. The BS of claim 13, wherein the at least one processor is configured to execute the computer-executable instructions to further cause the BS to:
transmit, to the UE, information related to whether the BS is configured with at least one of the cell-DTX mechanism and the cell-DRX mechanism.

17. The BS of claim 16, wherein the information is carried in a radio resource control (RRC) parameter.

18. The BS of claim 13, wherein the at least one processor is configured to execute the computer-executable instructions to further cause the BS to:
receive, from the UE, a scheduling request (SR) in an active time of the cell-DRX mechanism according to the second configuration.
